(19) United States
(12) Patent Application Publication
(10) Pub. No.: US 2012/0087791 A1
(43) Pub. Date: Apr. 12, 2012

(54) WIND TURBINE DEVICE

(76) Inventor: Johannes Waarseth-Junge, Stavanger (NO)

(21) Appl. No.: 13/377,173

(22) PCT Filed: Jan. 22, 2010
(86) PCT No.: PCT/EP2010/050735

§ 371 Date: Dec. 9, 2011

(30) Foreign Application Priority Data
Jun. 12, 2009 (NO) 20092276

(51) Int. Cl. F03D 1/04

(52) U.S. Cl. 415/220

(57) ABSTRACT

Wind turbine device comprising a rotor (1) provided with multiple rotor blades (13), wherein the rotor (1) is circumferentially encircled by a casing (2) including a forward and a rear casing section (21, 22) positioned mutually spaced having a spacing provided as an annular slit (23); and at least some of the rotor blades (13) in their outer end portions are provided with a rotor wing (14) arranged to fill an substantial part of the axial extent of the slit (23); as a forward and a rear casing section (21, 22) together with the rotor wing (14) forms a curved wing profile having a convex external surface (141, 211, 221) interrupted by the rotor wings (14) being arranged mutually circumferentially spaced.

The invention relates to a wind turbine device comprising a rotor provided with multiple rotor blades, more particularly that the rotor is circumferentially encircled by a casing penetrated by an annular slit; and that at least some of the rotor blades in their outermost end portions are provided with a rotor wing arranged to fill an substantial part of the axial extension of the slit; as a forward and a rear casing section together with the rotor wing forms a curved wing profile having a convex exterior surface interrupted by the rotor wings being arranged mutually, circumferentially spaced.

According to prior art, wind turbines essentially utilise the kinetic energy of the wind providing a force vector in the flow direction of the air acting on wind generator blades arranged essentially across the wind direction. Traditional wind generators of this type may be formed having a horizontal or a vertical axis of rotation. The wind turbine is made to rotate by a force component applying a torque to the generator rotor.

The object of the invention is to remedy or reduce at least one of the prior art drawbacks.

The object is achieved by the features stated in the description below and in the following claims.

The invention is based on the application of a lifting force to the wing in a direction outwards from the convex wing surface, also described by the so-called Bernoulli principle, by the movement of an air stream about a curved wing profile being convex on one side and flat, possibly concave or convex with a lesser curvature on an opposing side, due to the dissimilar length of the flow paths for the air on the two sides of the wing.

The invention provides a wind turbine comprising a rotor having rotor blades extending from a hub outwards toward an encircling, cylindrical casing arranged concentrically with the rotor. The casing is elongated and shaped as a circular wing, as it exhibits a cross-section having the profile of a wing, curved in a radial direction outwards. In the casing is arranged a continuous, annular slit. A forward and a rear section of the casing being then separated by said slit, are connected with each other by means of a series of struts arranged spaced on the exterior wing surface of the casing. The casing exhibits a forward edge that in an operational position faces the wind direction, and an opposing, relatively sharp, rear edge.

The radial rotor blades are in their outer end portions provided with wings arranged in the slit of the casing, as they exhibit an axial extent relative to a rotor rotational axis and which essentially fills the distance between the forward and rear sections of the casing. The rotor wings have a mutual spacing along the rotational path such that the rotor wings only partly close the slit in the casing. The profile of the rotor wings in a plane perpendicular to the rotational axis of the rotor is curved with a convex exterior shape for thereby to essentially coincide with the circular cross-section of the casing. A cross-section in the axis direction of the rotor exhibits curvatures, which essentially complements the wing profile of the casing. When the rotor wings move, the profile will thereby effect that a radially outwardly acting lifting force is generated due to the dissimilar flow path lengths on the outside and inside of the rotor wings. By the very fact that the rotor wings in this way essentially close portions of the casing slit, the casing will partly exhibit a whole wing profile, partly an interrupted wing profile, where the air may flow from the internal overpressure area to the radially external underpressure area.

Preferably the rotor wings exhibit a negative angle of attack, i.e. the distance of an internal rotor wing surface from the rotor axis increases from the forward edge of the rotor wing to the rear edge of the rotor wing. This causes the airflow arising through the casing in the spaces between the rotor wings to provide a pushing force against the rotor wing cooperating with the pushing force that the wind generates on the rotor blades causing rotation of the rotor.

The invention relates more particularly to a wind turbine device comprising a rotor provided with multiple rotor blades, characterised in that
the rotor is circumferentially encircled by a casing including a forward and a rear casing section positioned mutually spaced and provided as an annular slit; and
at least some of the rotor blades in their outer end portions are provided with a rotor wing arranged to fill an essential part of the axial extent of the slit; as

the forward and the rear casing section together with the rotor wings form a curved wing profile having a convex external surface interrupted by the rotor wings being arranged mutually spaced.

The casing may be provided with a rounded forward wing edge and a sharp rear wing edge.

The forward and rear casing sections may be mutually rigidly interconnected by struts arranged mutually spaced on the external surfaces of the casing.

The slit may constitute between ¼ and ⅖ of the total length of the casing in the axial direction.

The rotor wings may exhibit a wing profile having a concave inwardly directed curvature in a plane perpendicular to the rotor axis.

An external rotor wing surface may exhibit a curvature, which essentially corresponds to the resulting external curvature of the wing section casings both in their longitudinal and circumferential directions.

The rotor wings may exhibit a rounded forward wing edge and a sharp rear wing edge.

An internal rotor wing surface may exhibit an increasing distance from a rotor rotational axis in the direction from the forward wing edge to the rear wing edge.

In the following is described an example of a preferred embodiment which is illustrated in the accompanying drawings, wherein:

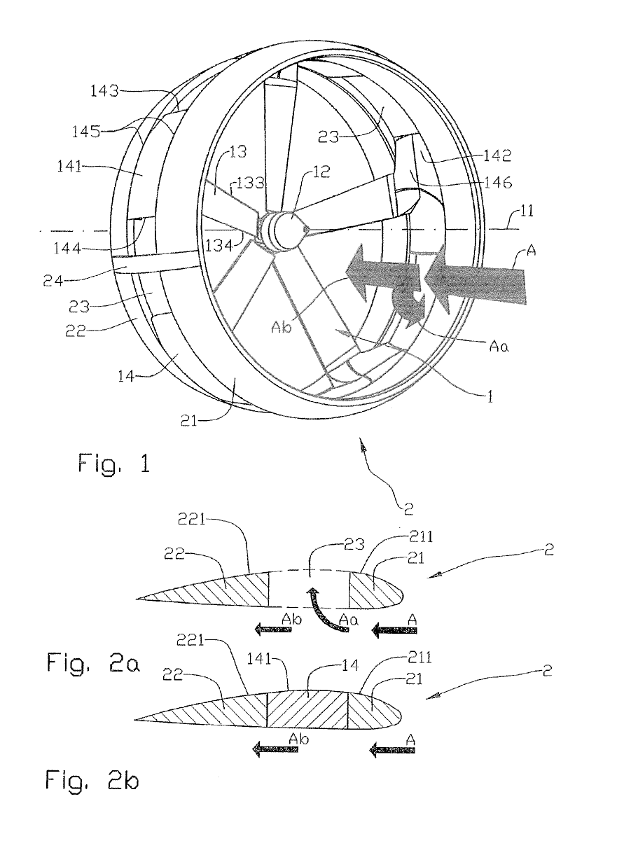

FIG. 1 shows a wind turbine according to the invention in perspective;

FIG. 2a shows a principle sketch of the rotor wing of the wind turbine in cross-section;

FIG. 2b shows a principle sketch of the wind turbine casing and a rotor wing;

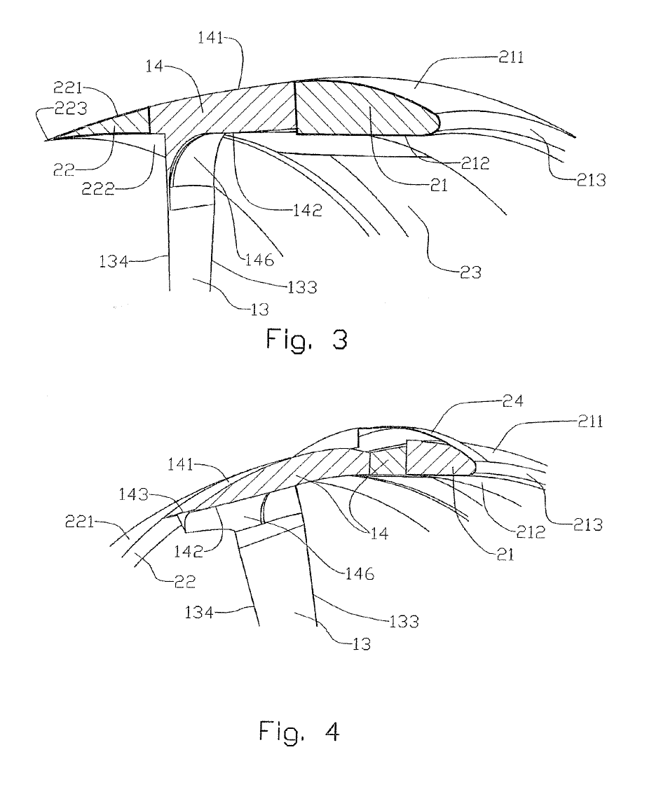

FIG. 3 shows in a larger scale an intersected segment of the wind turbine casing and rotor in an axial plane; and

FIG. 4 shows an intersected segment of a rotor wing, partly in a radial plane and partly in an axial plane; and also the forward casing section intersected in an axial plane.

In the figures the reference numeral 1 indicates a rotor provided with multiple rotor blades 13 extending radially outward from a hub 12 arranged on the input shaft (not shown) of a generator (not shown), as the central axis 11 of the hub 12 coincides with the central axis of the generator shaft. The end portions of each of the rotor blades 13 are provided with a rotor wing 14 essentially perpendicular to the longitudinal direction of the rotor blade 13. The rotor wings 14 exhibit an essentially rectangular outline having a forward and a rear rotor wing edge 143, 144 and two opposing parallel rotor wing side edges 145. There is provided a distance between the rear rotor wing edge 144 of a rotor wing 14 and the forward rotor wing edge 143 of the adjacent rotor wing 14. The distance is approximately equal to the extent of the rotor wing 14 in the direction of movement.

The rotor 1 is encircled by an essentially cylindrically shaped casing 2. The casing 2 is provided with an annular slit 23 between a forward and a rear casing section 21, 22. The casing sections 21, 22 are mutually rigidly interconnected by means of a series of connecting struts 24 arranged mutually spaced on the external circumference of the casing 2, as they extend in the axial direction of the casing 2.

The annular shaped slit 23 is arranged to contain the rotor wings 14, as the rotor wings 14 exhibit a width, i.e. a distance between the rotor wing side edges 145 providing a clearance between the side edges of the rotor wing 14 and the slit 23.

The casing 2 exhibits a curved wing profile having a convex external surface formed by the external forward and rear casing section surfaces 211, 221 interrupted by said slit 23 (see particularly FIG. 2a). An external surface 141 on the rotor wing 14 has a shape corresponding to the adjacent external casing section surfaces 211, 221 and results in a partly uninterrupted casing wing profile (see particularly FIG. 2b).

Each of the rotor wings 14 exhibits a curved wing profile as seen in the longitudinal section of the rotor wing 14 (see particularly FIG. 3). The rotor wings 14 have a cross-section with a curvature essentially coinciding with the profile of the casing 2 (see particularly FIG. 4). The rotor wings 14 are arranged with a negative pitch angle relative to the movement path, which means that the rear wing edge 144 of the rotor wings 14 is a greater distance away from the rotor 1 central axis 11 than the forward wing edge 143 of the rotor wing 14.

The rotor blades 13 between the hub 12 and the rotor wings 14 have a per se known shape, as the cross-section has a wing shape having a rounded forward edge 133 and a relatively sharp rear edge. The rotor blades 13 have an increasing pitch angle relative to the central axis from the hub 12 toward the rotor wings 14. The width of the rotor blades 13 increases from the hub 12 toward the rotor wings 14. A rotor wing base 146 forms the transition between each rotor blade 13 and the appurtenant rotor wing 14.

The casing 2 is fixed relative to the generator (not shown) by means of a fastening arrangement (not shown). The fastening arrangement may at the same time form a rotatable support for the wind turbine in a support structure, such as in a tower (not shown).

When the wind turbine according to the invention is positioned in an air flow (see FIGS. 1 and 2a/2b) and rotated with the forward edge 213 of the casing 2 against the air flow A, the wing profile of the casing 2 will provide a pressure difference between the inside and the outside of the casing 2 with an underpressure on the outside of the casing 2. This will be attempted balanced, as a radial airflow Aa will flow through the openings formed between the rotor wings 14 arranged in the slit 23. The pushing force that the radial air flow Aa inflicts on the rotor wing 14 will, due to the pitch angle of the rotor wing 14, cause a pushing force having a circumferential component cooperating with a pushing force generated by an action of the axial air flow Aa against the rotor blades 13, as the pushing forces exhibit the same direction of attack and sets the rotor 1 in a rotating motion for driving the generator (not shown).

In addition to that the wing profile of the casing 2 in cooperation with that of the rotor wings 14 utilises a static pressure difference about the casing to thereby increase the efficiency of the wind turbine, the wing profile of the rotor wings themselves will cause a pressure difference between the underside and topside 142 and 141 respectively of the rotor wing 14, amplifying the pushing force generated on the rotor wings 14.

1. A wind turbine device comprising:
a rotor provided with multiple rotor blades;
wherein the rotor is circumferentially encircled by a casing comprising a forward and a rear casing section positioned mutually spaced, the spacing provided as an annular slit;
at least some of the rotor blades in their outer end portions are provided with a rotor wing arranged to fill a substantial part of an axial extent of the slit; and
wherein the forward and a rear casing sections together with the rotor wing forms a curved wing profile having a convex external surface interrupted by the rotor wings being arranged mutually spaced.

2. The device according to claim 1, wherein the casing is provided with a rounded forward wing edge and a sharp rear wing edge.

3. The device according to claim 1, wherein the forward and the rear casing sections are rigidly interconnected by struts arranged on the external surfaces of the casing.

4. The device according to claim 1, wherein the slit constitutes between ¼ and ⅖ of a total length of the casing in an axial direction.

5. The device according to claim 1, wherein the rotor wing in a plane perpendicular to the rotor axis direction exhibits a wing profile having inwardly directed concave curvature.

6. The device according to claim 1, wherein an external rotor wing surface exhibits a curvature essentially corresponding to a resulting external curvature of the wing section casings both regarding their length and circumferential directions.

7. The device according to claim 1, wherein the rotor wing exhibits a rounded forward wing edge and a sharp rear wing edge.

8. The device according to claim 7, wherein an internal rotor wing surface exhibits an increasing distance from a rotor rotational shaft in a direction from the rounded forward wing edge to the sharp rear wing edge.
